(19) United States
(12) Patent Application Publication
(10) Pub. No.: US 2023/0319095 A1
(43) Pub. Date: Oct. 5, 2023

(54) ASSESSING ENTITY RISK BASED ON EXPOSED SERVICES

(71) Applicant: FORESCOUT TECHNOLOGIES, INC., San Jose, CA (US)

(72) Inventor: Naor Kalbo, Givatayim (IL)

(21) Appl. No.: 17/993,709

(22) Filed: Nov. 23, 2022

Related U.S. Application Data
(60) Provisional application No. 63/326,619, filed on Apr. 1, 2022.

(51) Int. Cl. H04L 9/40

(52) U.S. Cl. CPC H04L 63/1433; H04L 63/1425

(57) ABSTRACT

Systems and methods for determining a risk associated with an entity based on exposed services are described. The risk determination may include determining one or more services exposed by ports of an entity and determining a level of exposure associated with the service corresponding to each of the one or more open ports of the entity. A risk level associated with the entity based at least in part on the level of exposure associated with the service corresponding to each of the one or more open ports of the entity.

### RELATED APPLICATIONS

This application claims priority from and the benefit of U.S. Provisional Patent Application No. 63/326,619 filed on Apr. 1, 2022, the entire contents of which is incorporated herein by reference in its entirety.

### TECHNICAL FIELD

Aspects and implementations of the present disclosure relate to network monitoring, and more specifically, identifying and ranking potential exposed services of an entity of a network and assessing entity risk based on the exposed services.

### BACKGROUND

As technology advances, the number and variety of devices or entities that are connected to communications networks are rapidly increasing. Each device or entity may have its own respective vulnerabilities which may leave the network open to compromise or other risks. Preventing the spreading of an infection of a device or entity, or an attack through a network can be important for securing a communication network.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative communication network in accordance with one implementation of the present disclosure.

FIG. 2 depicts an illustrative network topology in accordance with one implementation of the present disclosure.

FIG. 3A depicts a system diagram illustrating an example system for identifying and ranking potential services exposure to assess risk of an entity of a network, according to embodiments of the present disclosure.

FIG. 3B depicts a system diagram illustrating another example system for identifying and ranking potential services exposure to assess risk of an entity of a network, according to embodiments of the present disclosure.

FIG. 4 depicts a flow diagram illustrating an example process for assessing entity risk from potential services exposure of an entity of a network according to embodiments of the present disclosure.

FIG. 5 depicts a flow diagram illustrating an example process for assessing entity risk based on potential exposed services of the entity within a network according to embodiments of the present disclosure.

FIG. 6 depicts a flow diagram illustrating another example process of assessing entity risk based on potential exposed services of the entity within a network according to embodiments of the present disclosure.

FIG. 7 depicts illustrative components of a system for assessing entity risk based on exposed services of the entity within a network in accordance with one implementation of the present disclosure.

FIG. 8 is a block diagram illustrating an example computer system, in accordance with one implementation of the present disclosure.

### DETAILED DESCRIPTION

Aspects and implementations of the present disclosure are directed to identifying and ranking potential services exposure for entities of a network. The systems and methods disclosed can be employed with respect to network security, among other fields. More particularly, it can be appreciated that devices or entities with vulnerabilities are a significant and growing problem. At the same time, the proliferation of network-connected devices (e.g., internet of things (IoT) devices such as televisions, security cameras (internet protocol (IP) cameras), wearable devices, medical devices, etc.) can make it difficult to effectively ensure that network security is maintained. Classification of devices and risk assessment (e.g., identifying potential services exposure) can be particularly important for securing a network because lack of knowledge about what an entity is and potential vulnerabilities of the entity can prevent application of appropriate security measures. Accordingly, described herein in various implementations are systems, methods, techniques, and related technologies, which allow for improved identifying and ranking potential services exposure of an entity of a network to be used for device risk assessment and vulnerability remediation.

Conventionally, entity risk calculation formulas take into consideration the risky open ports of an entity (e.g., ports that may present security risk and exposure) when performing risk scoring. The use of open ports as a risk factor, however, is limited because an open port may not correctly represent the actual services bound to the port. Such cases may occur when the service runs on a non-default or unfamiliar port or when a port is bound to a non-default service. Accordingly, use of open ports leaves a gap where the risk presented will have limited coverage and accuracy, causing confusion and misunderstanding of the risks posed by the open ports.

Accordingly, described herein in various implementations are systems, methods, techniques, and related technologies, which provide for indicating an entity's potential attack surface based on exposed services rather that based on port. For example, the risks associated with a port may not be inherent of the port but rather the services exposed by that port. Accordingly, indicating potential attack surface based on exposed services provides a more accurate illustration of the risk. Embodiments may then take exposed services into consideration within an overall risk scoring of an entity to reflect exposure of the entity for both internal threat actors or external/remote threat actors.

In some embodiments, an exposed services component of an asset risk assessment system may generate, or obtain a dynamic mapping list, or table, including the desired services, protocol associated with those services and the corresponding port number. The mapping list may include services from various domains, such as information technology (IT), internet of things (IoT), internet of medical things (IoMT), and operational technology (OT) domains. The mapping list may categorize the services according to possible consequences depending on the impact levels of the service. For example, the impact levels may include 1) gain access and 2) gain control. A gain access impact level may indicate that a service potentially allows a third-party entity to gather, collect, or otherwise access valuable information from the targeted entity. A gain control impact level may indicate that a service potentially allows a third-party entity to acquire limited or full control of the targeted entity.

In some embodiments, the exposed services component may identify an exposed service via a reverse lookup translation from a port to a service within the mapping list or by using automated/scripted techniques to detect the service associated with a port without performing a reverse lookup (e.g., via deep packet inspection (DPI) of network traffic from the port). Additionally, the exposed services component may identify services that may correlate to several open ports and protocols (e.g., multiple hypertext transfer protocol (HTTP) services on different ports with different protocols). Accordingly, embodiments described herein provide for improved accuracy of risk assessment based on services rather than ports. Potential attack surfaces can therefore be dynamically and accurately determined for any entity of a network.

It can be appreciated that the described technologies are directed to and address specific technical challenges and longstanding deficiencies in multiple technical areas, including but not limited to network security, monitoring, and policy enforcement. It can be further appreciated that the described technologies provide specific, technical solutions to the referenced technical challenges and unmet needs in the referenced technical fields.

Network segmentation can be used to enforce security policies on a network, for instance in large and medium organizations, by restricting portions or areas of a network which an entity can access or communicate with. Segmentation or “zoning” can provide effective controls to limit movement across the network (e.g., by a hacker or malicious software). Enforcement points including firewalls, routers, switches, cloud infrastructure, other network devices/entities, etc., may be used to enforce segmentation on a network (and different address subnets may be used for each segment). Enforcement points may enforce segmentation by filtering or dropping packets according to the network segmentation policies/rules. The viability of a network segmentation project depends on the quality of visibility the organization has into its entities and the amount of work or labor involved in configuring network entities.

Although embodiments are described herein with reference to network devices, embodiments also apply to any entity communicatively coupled to the network. An entity or entities, as discussed herein, include devices (e.g., computer systems, for instance laptops, desktops, servers, mobile devices, IoT devices, OT devices, etc.), endpoints, virtual machines, services, serverless services (e.g., cloud-based services), containers (e.g., user-space instances that work with an operating system featuring a kernel that allows the existence of multiple isolated user-space instances), cloud-based storage, accounts, and users. Depending on the entity, an entity may have an IP address (e.g., a device) or may be without an IP address (e.g., a serverless service).

The enforcement points may be one or more network entities (e.g., firewalls, routers, switches, virtual switch, hypervisor, software defined network (SDN) controller, virtual firewall, etc.) that are able to enforce access or other rules, access control lists (ACLs), or the like to control (e.g., allow or deny) communication and network traffic (e.g., including dropping packets) between the entity and one or more other entities communicatively coupled to a network. Access rules may control whether an entity can communicate with other entities in a variety of ways including, but not limited to, blocking communications (e.g., dropping packets sent to one or more particular entities), allowing communication between particular entities (e.g., a desktop and a printer), allowing communication on particular ports, etc. It is appreciated that an enforcement point may be any entity that is capable of filtering, controlling, restricting, or the like communication or access on a network.

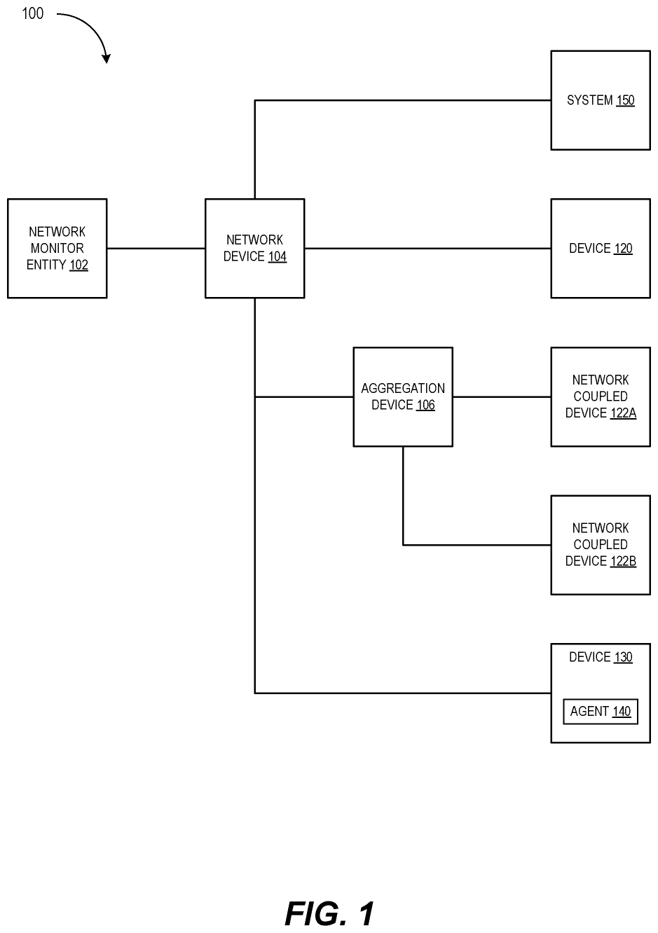

FIG. 1 depicts an illustrative communication network 100, in accordance with one implementation of the present disclosure. The communication network 100 includes a network monitor entity 102, a network device 104, an aggregation device 106, a system 150, devices 120 and 130, and network coupled devices 122A-B. The devices 120 and 130 and network coupled devices 122A-B may be any of a variety of devices including, but not limited to, computing systems, laptops, smartphones, servers, Internet of Things (IoT) or smart devices, supervisory control and data acquisition (SCADA) devices, operational technology (OT) devices, campus devices, data center devices, edge devices, etc. It is noted that the devices/entities of communication network 100 may communicate in a variety of ways including wired and wireless connections and may use one or more of a variety of protocols.

Network device 104 may be one or more network entities configured to facilitate communication among aggregation device 106, system 150, network monitor entity 102, devices 120 and 130, and network coupled devices 122A-B. Network device 104 may be one or more network switches, access points, routers, firewalls, hubs, etc.

Network monitor entity 102 may be operable for a variety of tasks including identifying and ranking potential services exposure of entities of a network and assessing risk of the entity based on the services exposure. For example, the network monitor entity 102 may determine, as described herein, one or more open ports of an entity coupled to the network. The network monitor entity 102 may further determine a service associated with the open ports (e.g., a type of service tied to each of the open ports). For example, the network monitor entity 102 may reference a mapping list of ports and the services corresponding to those ports. Thus, the network monitor entity 102 may determine the services associated with the open ports of the entity based on the mapping list. In some examples, the mapping list may further include an impact level associated with the identified services. Accordingly, the network monitor entity 102 may determine the services and the corresponding security impact level of each of the open ports of the entity. Thus, the network monitor entity 102 may be able to more accurately determine and indicate the security impacts of the open ports of the entity. In some embodiments, the network monitor entity 102 may further determine a risk score for the entity based at least in part on the exposed services of the open ports.

Network monitor entity 102 may be a computing system, network device (e.g., router, firewall, an access point), network access control (NAC) device, intrusion prevention system (IPS), intrusion detection system (IDS), deception device, cloud-based device, virtual machine based system, etc. Network monitor entity 102 may be communicatively coupled to the network device 104 in such a way as to receive network traffic flowing through the network device 104 (e.g., port mirroring, sniffing, acting as a proxy, passive monitoring, etc.). In some embodiments, network monitor entity 102 may include one or more of the aforementioned devices. In various embodiments, network monitor entity 102 may further support high availability and disaster recovery (e.g., via one or more redundant devices).

In some embodiments, network monitor entity 102 may monitor a variety of protocols (e.g., Samba, hypertext transfer protocol (HTTP), secure shell (SSH), file transfer protocol (FTP), transfer control protocol/internet protocol (TCP/IP), user datagram protocol (UDP), Telnet, HTTP over secure sockets layer/transport layer security (SSL/TLS), server message block (SMB), point-to-point protocol (PPP), remote desktop protocol (RDP), windows management instrumentation (WMI), windows remote management (WinRM), etc.).

The monitoring of entities by network monitor entity 102 may be based on a combination of one or more pieces of information including traffic analysis, information from external or remote systems (e.g., system 150), communication (e.g., querying) with an aggregation device (e.g., aggregation device 106), and querying the device itself (e.g., via an application programming interface (API), command line interface (CLI), web interface, simple network management protocol (SNMP), etc.), which are described further herein. Network monitor entity 102 may be operable to use one or more APIs to communicate with aggregation device 106, device 120, device 130, or system 150. Network monitor entity 102 may monitor for or scan for entities that are communicatively coupled to a network via a network address translation (NAT) device (e.g., firewall, router, etc.) dynamically, periodically, or a combination thereof.

Information from one or more external or 3^{rd} party systems (e.g., system 150) may further be used for determining one or more tags or characteristics for an entity. For example, a vulnerability assessment (VA) system may be queried to verify or check if an entity is in compliance and provide that information to network monitor entity 102. External or 3^{rd} party systems may also be used to perform a scan or a check on an entity to determine a software version.

Device 130 can include agent 140. The agent 140 may be a hardware component, software component, or some combination thereof configured to gather information associated with device 130 and send that information to network monitor entity 102. The information can include the operating system, version, patch level, firmware version, serial number, vendor (e.g., manufacturer), model, asset tag, software executing on an entity (e.g., anti-virus software, malware detection software, office applications, web browser(s), communication applications, etc.), services that are active or configured on the entity, ports that are open or that the entity is configured to communicate with (e.g., associated with services running on the entity), media access control (MAC) address, processor utilization, unique identifiers, computer name, account access activity, etc. The agent 140 may be configured to provide different levels and pieces of information based on device 130 and the information available to agent 140 from device 130. Agent 140 may be able to store logs of information associated with device 130. Network monitor device 102 may utilize agent information from the agent 140. While network monitor entity 102 may be able to receive information from agent 140, installation or execution of agent 140 on many entities may not be possible, e.g., IoT or smart devices.

System 150 may be one or more external, remote, or third-party systems (e.g., separate) from network monitor entity 102 and may have information about devices 120 and 130 and network coupled devices 122A-B. System 150 may include a vulnerability assessment (VA) system, a threat detection (TD) system, endpoint management system, a mobile device management (MDM) system, a firewall (FW) system, a switch system, an access point system, etc. Network monitor entity 102 may be configured to communicate with system 150 to obtain information about devices 120 and 130 and network coupled devices 122A-B on a periodic basis, as described herein. For example, system 150 may be a vulnerability assessment system configured to determine if device 120 has a computer virus or other indicator of compromise (IOC).

The vulnerability assessment (VA) system may be configured to identify, quantify, and prioritize (e.g., rank) the vulnerabilities of an entity. The VA system may be able to catalog assets and capabilities or resources of an entity, assign a quantifiable value (or at least rank order) and importance to the resources, and identify the vulnerabilities or potential threats of each resource. The VA system may provide the aforementioned information for use by network monitor entity 102. In some examples, the VA system may identify and rank potential services exposure of entities of a network. For example, the VA system may determine one or more open ports of an entity coupled to the network. The VA system may further determine a service associated with the open ports (e.g., a type of service tied to each of the open ports). For example, the VA system may reference a mapping list of ports and the services corresponding to those ports. Thus, the VA system may determine the services associated with the open ports of the entity based on the mapping list. In some examples, the mapping list may further include an impact level associated with the identified services. Accordingly, the VA system may determine the services and the corresponding security impact level of each of the open ports of the entity. Thus, the VA system may be able to more accurately determine and indicate the security impacts of the open ports of the entity. In some embodiments, the VA system may further determine a risk score for the entity based at least in part on the exposed services of the open ports.

The advanced threat detection (ATD) or threat detection (TD) system may be configured to examine communications that other security controls have allowed to pass. The ATD system may provide information about an entity including, but not limited to, source reputation, executable analysis, and threat-level protocols analysis. The ATD system may thus report if a suspicious file has been downloaded to an entity being monitored by network monitor entity 102.

Endpoint management systems can include anti-virus systems (e.g., servers, cloud-based systems, etc.), next-generation antivirus (NGAV) systems, endpoint detection and response (EDR) software or systems (e.g., software that record endpoint-system-level behaviors and events), compliance monitoring software (e.g., checking frequently for compliance).

The mobile device management (MDM) system may be configured for administration of mobile devices, e.g., smartphones, tablet computers, laptops, and desktop computers. The MDM system may provide information about mobile devices managed by MDM system including operating system, applications (e.g., running, present, or both), data, and configuration settings of the mobile devices and activity monitoring. The MDM system may be used get detailed mobile device information which can then be used for device monitoring (e.g., including device communications) by network monitor entity 102.

The firewall (FW) system may be configured to monitor and control incoming and outgoing network traffic (e.g., based on security rules). The FW system may provide information about an entity being monitored including attempts to violate security rules (e.g., unpermitted account access across segments) and network traffic of the entity being monitored.

The switch or access point (AP) system may be any of a variety of network entities (e.g., network device 104 or aggregation device 106) including a network switch or an access point, e.g., a wireless access point, or combination thereof that is configured to provide an entity access to a network. For example, the switch or AP system may provide MAC address information, address resolution protocol (ARP) table information, device naming information, traffic data, etc., to network monitor entity 102 which may be used to monitor entities and control network access of one or more entities. The switch or AP system may have one or more interfaces for communicating with IoT or smart devices or other entities (e.g., ZigBee™, Bluetooth™, etc.), as described herein. The VA system, ATD system, and FW system may thus be accessed to get vulnerabilities, threats, and user information of an entity being monitored in real-time which can then be used to determine a risk level of the entity.

Aggregation device 106 may be configured to communicate with network coupled devices 122A-B and provide network access to network coupled devices 122A-B. Aggregation device 106 may further be configured to provide information (e.g., operating system, device software information, device software versions, device names, application present, running, or both, vulnerabilities, patch level, etc.) to network monitor entity 102 about the network coupled devices 122A-B. Aggregation device 106 may be a wireless access point that is configured to communicate with a wide variety of entities through multiple technology standards or protocols including, but not limited to, Bluetooth™, Wi-Fi™, ZigBee™, Radio-frequency identification (RFID), Light Fidelity (Li-Fi), Z-Wave, Thread, Long Term Evolution (LTE), Wi-Fi™ HaLow, HomePlug, Multimedia over Coax Alliance (MoCA), and Ethernet. For example, aggregation device 106 may be coupled to the network device 104 via an Ethernet connection and coupled to network coupled devices 122A-B via a wireless connection. Aggregation device 106 may be configured to communicate with network coupled devices 122A-B using a standard protocol with proprietary extensions or modifications.

Aggregation device 106 may further provide log information of activity and attributes of network coupled devices 122A-B to network monitor entity 102. It is appreciated that log information may be particularly reliable for stable network environments (e.g., where the types of entities on the network do not change often). The log information may include information of updates of software of network coupled devices 122A-B.

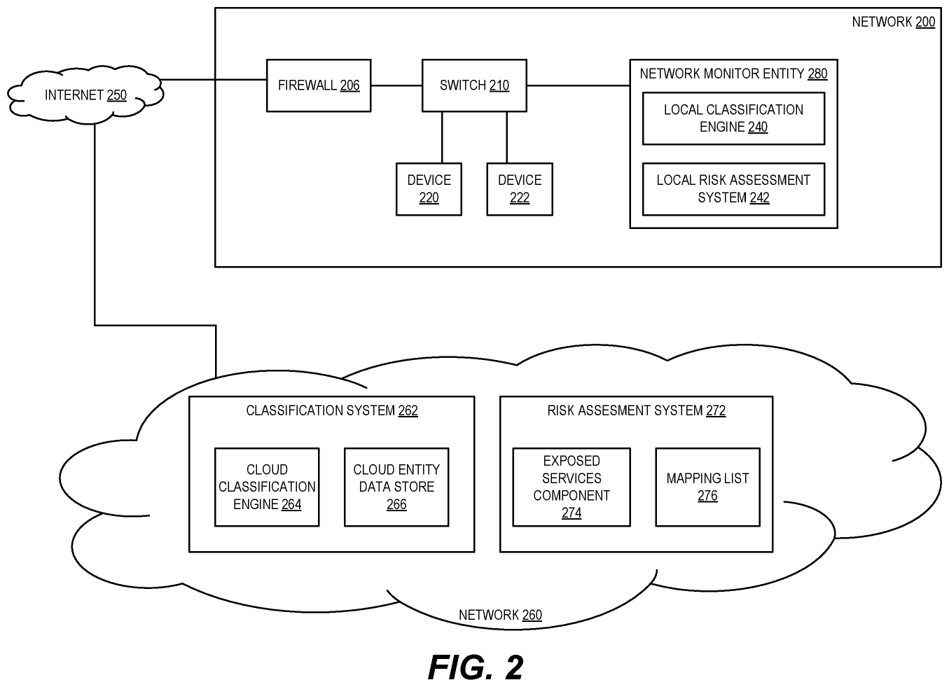

FIG. 2 depicts an example network 200 with multiple enforcement points (e.g., firewall 206 and switch 210) and a network monitor entity 280 (e.g., network monitor entity 102) which can perform risk assessment based on exposed services of a device, as described herein, associated with the various entities communicatively coupled in example network 200.

FIG. 2 further shows example devices 220-222 (e.g., devices 106, 122A-B, 120, and 130, other physical or virtual devices, other entities, etc.) and it is appreciated that more or fewer network entities or other entities may be used in place of the devices of FIG. 2. Example devices 220-222 may be any of a variety of devices or entities (e.g., smart devices, multimedia devices, networking devices, accessories, mobile devices, IoT devices, retail devices, healthcare devices, etc.), as described herein. Enforcement points including firewall 206 and switch 210 may be any device (e.g., network device 104, cloud infrastructure, etc.) that is operable to allow traffic to pass, drop packets, restrict traffic, etc. Network monitor entity 280 may be any of a variety of network devices or entities, e.g., router, firewall, an access point, network access control (NAC) device, intrusion prevention system (IPS), intrusion detection system (IDS), deception device, cloud-based entity or device, virtual machine based system, etc. Network monitor entity 280 may be substantially similar to network monitor entity 102. Embodiments support IPv4, IPv6, and other addressing schemes. In some embodiments, network monitor entity 280 may be communicatively coupled with firewall 206 and switch 210 through additional individual connections (e.g., to receive or monitor network traffic through firewall 206 and switch 210).

Switch 210 communicatively couples the various entities of network 200 including firewall 206, network monitor entity 280, and devices 220-222. Firewall 206 may perform network address translation (NAT). Firewall 206 communicatively couples network 200 to Internet 250 and firewall 206 may restrict or allow access to Internet 250 based on particular rules or ACLs configured on firewall 206. Firewall 206 and switch 210 are enforcement points, as described herein.

Network monitor entity 280 can access network traffic from network 200 (e.g., via port mirroring or SPAN ports of firewall 206 and switch 210 or other methods). Network monitor entity 280 can perform passive scanning of network traffic by observing and accessing portions of packets from the network traffic of network 200. Network monitor entity 280 may perform an active scan of an entity of network 200 by sending one or more requests to the entity of network 200. The information from passive and active scans of entities of network 200 can be used to determine one or more features associated with the entities of network 200 (e.g., evidence).

Network monitor entity 280 includes local classification engine 240 which may perform classification of the entities of network 200 including firewall 206, switch 210, and devices 220-222. Local classification engine 240 may designate attributes and classify one or more entities of network 200 based on the information collected for the entities. Local classification engine 240 can send data (e.g., attribute values) about entities of network 200, as determined by local classification engine 240, to classification system 262. Local classification engine 240 may encode and encrypt the data prior to sending the data to classification system 262. Local classification engine 240 may receive a classification from classification system 262 which network monitor entity 280 can use to perform various security related measures. In some embodiments, classification of an entity may be performed in part by local network monitor entity 280 (e.g., local classification engine 240) and in part by classification system 262.

Network 260 may be a cloud-based network including one or more interconnections between a plurality of cloud computing entities or devices. Classification system 262 may be a cloud classification system within network 260 operable to perform device classification, as described herein. In some embodiments, classification system 262 may be part of a larger system operable to perform a variety of functions, e.g., part of a cloud-based network monitor entity, security device, etc., using network 260. For example, classification system 262 can perform cloud-based classification of devices via cloud-based network 260. Cloud classification engine 264 may perform classification of devices of the network 200 (e.g., devices 220-222). For example, cloud classification engine 264 may classify, or fingerprint, devices based on device profiles (e.g., device properties, features, attributes, characteristics, etc. collected by network monitor entity 280) stored at cloud entity data store 266.

Cloud entity data store 266 is not subject to the resource conditions or limitations (e.g., processing power, storage, etc.) that may impact network monitor entity 280 (e.g., and local classification engine 240). Cloud entity data store 266 is a data store (e.g., a cloud entity database) of entity information that has been uploaded to classification system 262. For example, the data in cloud entity data store 266 may include evidence associated with an entity, such as entity or device name, operating system, function, vendor/model, host information from a variety of networks (e.g., that have network monitor entities configured to upload device information), and other entity properties.

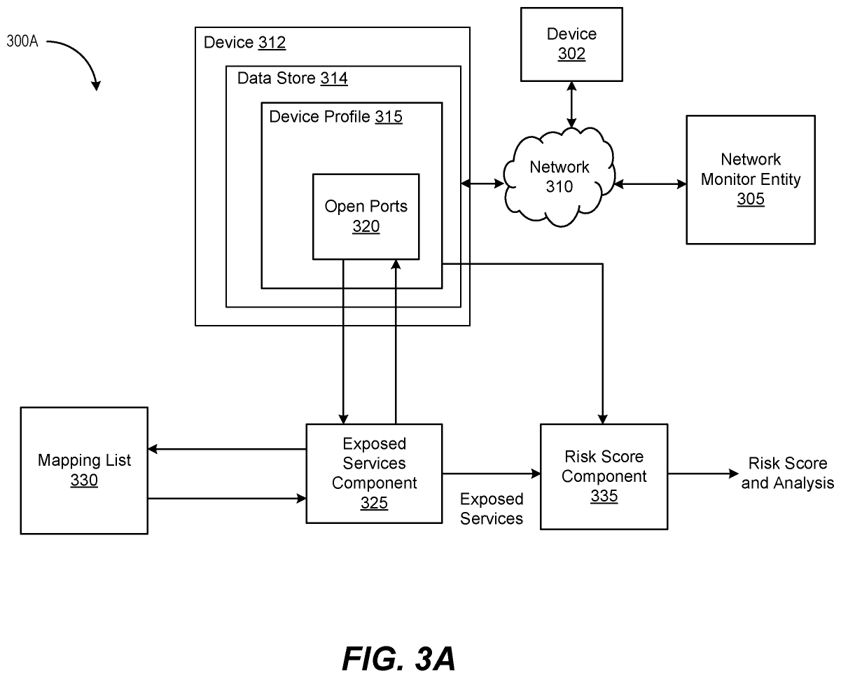

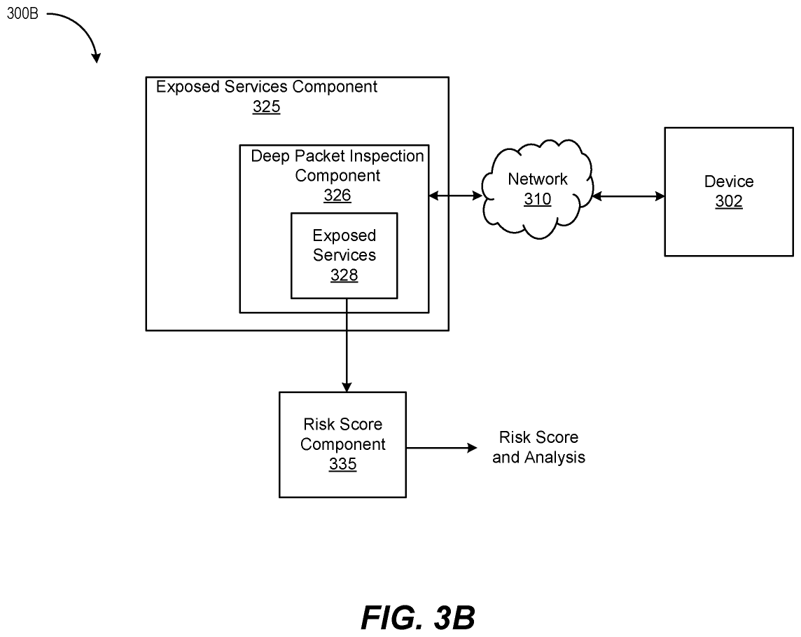

Risk assessment system 272 may determine potential security risks associated with each of the devices coupled to the network 200. As depicted, risk assessment system 272 includes an exposed services component 274 to identify and rank services exposed by open ports of an entity. For example, the exposed services component 274 may determine exposed services based on a mapping list 276 indicating services associated with ports of an entity as well as impact levels associated with the ports, as described in more detail below with respect to FIGS. 3-6. For example, the mapping list 276 may define one or more services that correspond to a particular port of a device of the network 200. In some embodiments, the exposed services component 274 may for example, store the mapping list locally 276 or retrieve the mapping list 276 from a database or data store. The mapping list 276 may be generated based on known, or collected, information associated with a device or entity and the services that typically or atypically are associated with a port of a device or entity. Local risk assessment system 242 of the network monitor entity 280 may perform the same or similar functions as the risk assessment system 272, locally.

FIG. 3A depicts a system 300A for identifying and ranking exposed services of a device or entity coupled to a network for entity risk assessment, according to some embodiments of the disclosure. System 300A includes device 302, device 312, and network monitor entity 305 coupled via network 310. Network monitor entity 305 may actively or passively monitor device 302 and aggregate information about the device 302 into a device profile 315 (e.g., at a data store 314 of device 312). In some examples, the network monitor entity 305 may identify open ports 320 of the device 302 to be included in the device profile 315. Although depicted as stored at a data store 314 of a separate device 312, the device profile 315 may also be stored locally at the network monitor entity 305, or remotely (e.g., cloud storage, remote database, etc.).

In some examples, an exposed services component 325 (e.g., of a risk assessment system) may retrieve or otherwise obtain the open ports 320 from the device profile 315 associated with the device 302. The exposed services component 325 may perform a lookup in a mapping list 330 using the open ports 320. In some embodiments, the mapping list 330 may include ports and services corresponding to the ports for devices similar to device 302 as well as any other types of devices or entities. As an example, the mapping list 330 for a particular device on a network may indicate that Secure Shell Protocol (port 22 over TCP) or Remote Desktop Protocol (port 3389 over TCP) or File Transfer Protocol (port 21 over TCP) or any other service to port correlation. The exposed services component 325 may identify the services corresponding to the open ports 320 of the device 302 from the mapping list 330 via a reverse lookup translation or any other search techniques. In some examples, the service that is running on a port of the entity may be a service that does not typically run on that port according to traditional or known service deployment (e.g., non-default or non-standard port assignment). For example, Telnet service that runs over port 2323, or File Transfer Protocol that runs over port 2121 may be non-standard port assignments. Additionally, in some examples a service may run on multiple various ports of an entity. For example, an entity may have several HTTP services enabled simultaneously on ports TCP/80, TCP/8081, and UDP/653. Accordingly, the exposed services component 325 may also identify the services that are operating on atypical or non-standard ports as well as services that are operating on multiple ports.

In some examples, the exposed services component 325 may also identify an impact level associated with the identified services. The exposed services component 325 may then provide the identified exposed services and impact levels to a risk score component 335. The risk score component 335 may determine a risk score indicating a security risk associated with the device 302 based on the exposed services and other device profile 315 information. Additionally, the exposed services component 325, the risk score component 335, or a combination thereof may provide additional information or analysis of the exposed services and their associated risks such that a user or administrator may take appropriate remediation or security actions. The operations of system 300A described above may be performed locally within a network (e.g., by network monitor entity 280 of network 200), remotely within a cloud-based network (e.g., by classification system 262 and risk assessment system 272 of network 260), or a combination thereof.

FIG. 3B depicts a system 300B for identifying and ranking exposed services of a device or entity coupled to a network, according to embodiments of the disclosure. System 300B includes a device 302 coupled to a network 310. Exposed services component 325 may be the same or similar to exposed services component 325 described in FIG. 3. In some examples, exposed services component 325 may be included in a network monitor entity, a risk assessment system, or any other network connected device. The exposed services component 325 may include a deep packet inspection component 326 which may extract detailed information about the device 302 from network traffic to and from the device 302. In some embodiments, the deep packet inspection component 326 may identify the services that are associated with open ports of the device 302. For example, the deep packet inspection component 326 may extract information from packets sent to or from ports of the device 302. The information may indicate a protocol, the port, as well as the service operating behind the port. Accordingly, the deep packet inspection component 326 may determine the exposed services 328 operating on the device 302. Exposed services 328 may be data or a data structure indicating the services that are exposed by the open ports of a device or entity. In some examples, the exposed services component 325 may also determine an impact level or risk level associated with each of the exposed services 328 (e.g., based on a mapping list 330 as described with respect to FIG. 3A). The exposed services component 325 may provide the exposed services 328 and the impact levels to a risk score component 335 to determine an overall risk score for the device 302. The risk score may be a numerical representation of the security risk the device 302 poses to the network 310. The operations of system 300B described above may be performed locally within a network (e.g., by network monitor entity 280 of network 200), in a cloud-based network (e.g., by classification system 262 and risk assessment system 272 of network 260), or a combination thereof.

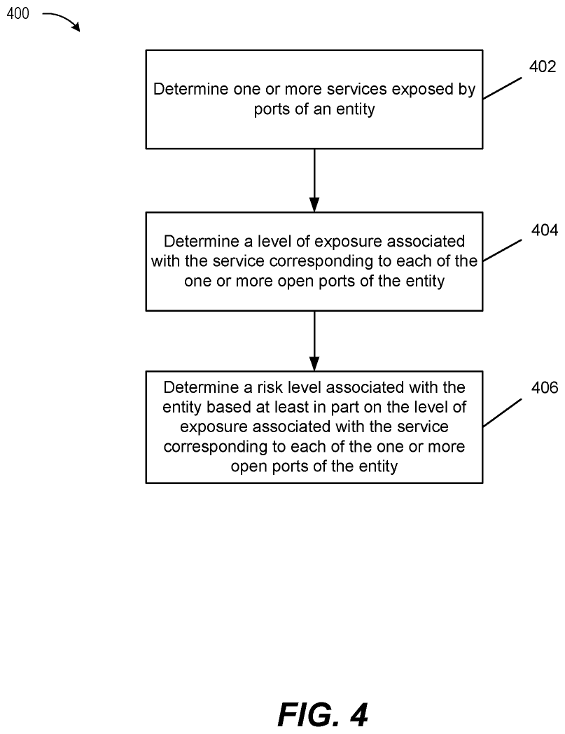

With reference to FIGS. 4-6, flowcharts 400-600 illustrate example operations used by various embodiments. Although specific operation blocks (“blocks”) are disclosed in flowcharts 400-500, such blocks are examples. That is, embodiments are well suited to performing various other blocks or variations of the blocks recited in flowcharts 400-600. It is appreciated that the blocks in flowcharts 400-600 may be performed in an order different than presented, and that not all of the blocks in flowcharts 400-600 may be performed. The blocks of flowcharts 400-600 may be performed locally by an entity, in a cloud, or a combination thereof.

FIG. 4 depicts a flow diagram of aspects of a process 400 for determining a risk level of an entity based on exposed services of the entity coupled to a network in accordance with one implementation of the present disclosure. Various portions of process 400 may be performed by different components (e.g., components of system 700, components of FIG. 3A, components of FIG. 3B, network monitor entity 102, network monitor entity 280) of an entity or device (e.g., network monitor entity 102, network monitor entity 280, or risk assessment system 272).

Process 400 begins at block 402, where processing logic (e.g., local risk assessment system 242, exposed service component 274, exposed services component 325, etc.) determines one or more services exposed by ports of an entity. The processing logic may identify one or more ports of the entity that are open for communication with other devices or entities of a network. The processing logic may then determine the services that are exposed by the one or more open ports of the entity. For example, the processing logic may determine the exposed services via a mapping (e.g., a mapping list or any other data structure) between ports of the entity and services known to operate on or to be associated with the ports of the entity. In another embodiment, the processing logic may identify the open ports by monitoring network traffic associated with the entity and identity the open ports from one or more properties extracted from the network traffic (e.g., via deep-packet inspection or other property extraction techniques).

At block 404, the processing logic (e.g., local risk assessment system 242, exposed service component 274, exposed services component 325 or risk score component 335) determines a level of exposure associated with the service corresponding to each of the one or more open ports of the entity. In some embodiments, the processing logic may determine an impact level associated with each of the services exposed by the ports of the entity. For example, each service of the entity may have an impact level determined based on the amount of exposure and risk due to a level of control of the entity that the service may allow a malicious actor to obtain if compromised. In some examples, the impact level may be determined based on whether the service allows the actor to gather, collect, and access the entity's valuable information or to gain limited or full control of the entity.

At block 406, the processing logic (e.g., local risk assessment system 242, risk assessment system 272, or risk score component 335) determines a risk level associated with the entity based at least in part on the level of exposure associated with the service corresponding to each of the one or more open ports of the entity. The processing logic may determine the risk level of the entity based on the impact level of each of the services exposed by open ports of the entity. For example, the processing logic may aggregate the risk contributed by each of the services into a single risk score for the device. In some examples, the risk score may also be determined based on additional information extracted about the device, such as additional entity properties, a classification of the entity, a fingerprint of the entity, etc.

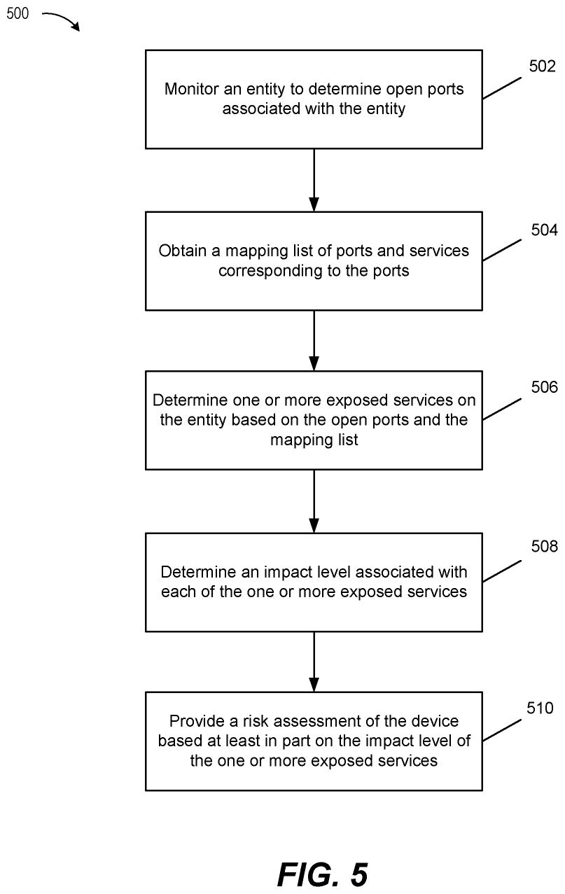

FIG. 5 depicts a flow diagram of aspects of a process 500 for determining a risk level of an entity based on exposed services of the entity coupled to a network in accordance with one implementation of the present disclosure. Various portions of process 500 may be performed by different components (e.g., components of system 700, components of FIG. 3A, components of FIG. 3B, network monitor entity 102, network monitor entity 280) of an entity or device (e.g., network monitor entity 102, network monitor entity 280, or risk assessment system 272). Process 500 begins at block 502, where processing logic (e.g., exposed services component 325) monitors an entity to determine open ports associated with the entity.

At block 504, the processing logic (e.g., local risk assessment system 242, exposed service component 274, exposed services component 325 etc.) obtains a mapping list of ports and services corresponding to the ports. In some embodiments, the mapping list may be generated and dynamically updated based researcher analysis or automated collection of port and service associations of different types of devices (e.g., based on local, cloud, or a combination thereof analysis).

At block 506, the processing logic (e.g., local risk assessment system 242, exposed service component 274, exposed services component 325 etc.) determines one or more exposed services on the entity based on the open ports and the mapping list. For example, the processing logic may perform a lookup in the mapping list to determine the services that are associated with the open ports of the entity.

At block 508, processing logic (e.g., local risk assessment system 242, exposed service component 274, exposed services component 325 etc.) determines an impact level associated with each of the one or more exposed services. The impact level may indicate whether a malicious actor may access the entity or obtain a level of control of the entity. In some examples, the impact level indicates the potential impact resulting from compromise of the exposed service and may be determined by a research team. In some examples, the impact levels of services can be continuously or intermittently updated based on new information such as additional observation and cyber-security expert knowledge. The mapping list may indicate the impact level for the exposed services.

At block 510, processing logic (e.g., local risk assessment system 242, exposed service component 274, exposed services component 325, risk score component 335, etc.) provides a risk assessment of the device based at least in part on the one or more exposed services, the impact level of each the one or more exposed services, or any combination thereof. The risk assessment may be expressed as a risk score. The risk score may be a quantitative indicator of the risk posed by device to the network. For example, the larger the number of exposed services and the higher the impact level of the exposed services the higher the risk score. In some examples, the risk assessment may include an indication of the services that are exposed by the open ports and the effect the exposed services have on the risk score. The risk assessment and risk score of the entity may be further determined based on any number of additional factors and features associated with the entity and the network.

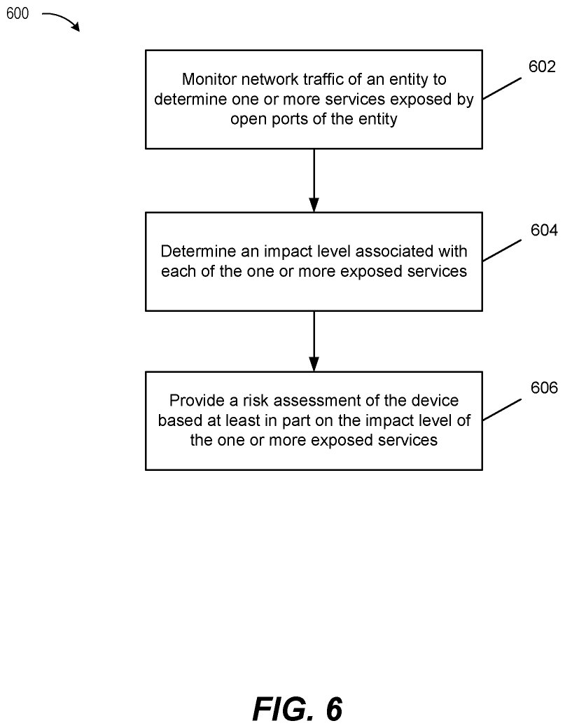

FIG. 6 depicts a flow diagram of aspects of process 600 for identifying and ranking exposed services of a device or entity coupled to a network in accordance with one implementation of the present disclosure. Various portions of process 600 may be performed by different components (e.g., components of system 700) of an entity or device (e.g., network monitor entity 102, network monitor entity 280, or risk assessment system 272).

Process 600 begins at block 602, where processing logic (e.g., network monitor entity 102, network monitor entity 280, or risk assessment system 272) monitors network traffic of an entity to determine one or more services exposed by open ports of the entity. In some embodiments, the processing logic may extract information identifying the exposed services directly from network traffic associated with the entity. For example, the processing logic may perform deep packet inspection (DPI) on packets received from and directed to open ports of the entity. The deep packet inspection may extract information identifying the service behind an open port and the protocols being used by the service. Accordingly, the processing logic may determine the services exposed by open ports of the entity without performing a lookup in a mapping list (e.g., as described above with respect to FIG. 3A and FIG. 5).

At block 604, the processing logic (e.g., network monitor entity 102, network monitor entity 280, or risk assessment system 272) determines an impact level associated with each of the one or more exposed services. The impact level may indicate one or more potential security risks, vulnerabilities, other security risks, or a combination thereof associated with the exposed services. For example, the impact levels may include gain access or gain control. In some examples, any number or type of impact levels may be used to determine the security impact of the one or more exposed services.

At block 606, the processing logic (e.g., network monitor entity 102, network monitor entity 280, or risk assessment system 272) provides a risk assessment of the device or entity based at least in part on the impact level of the one or more exposed services. The processing logic may calculate a risk score based on various information about the entity, including the impact levels of the one or more exposed services. The risk assessment may further include contextual information about the exposed services, the protocols used by the exposed services, and the potential security risks posed by the exposed services.

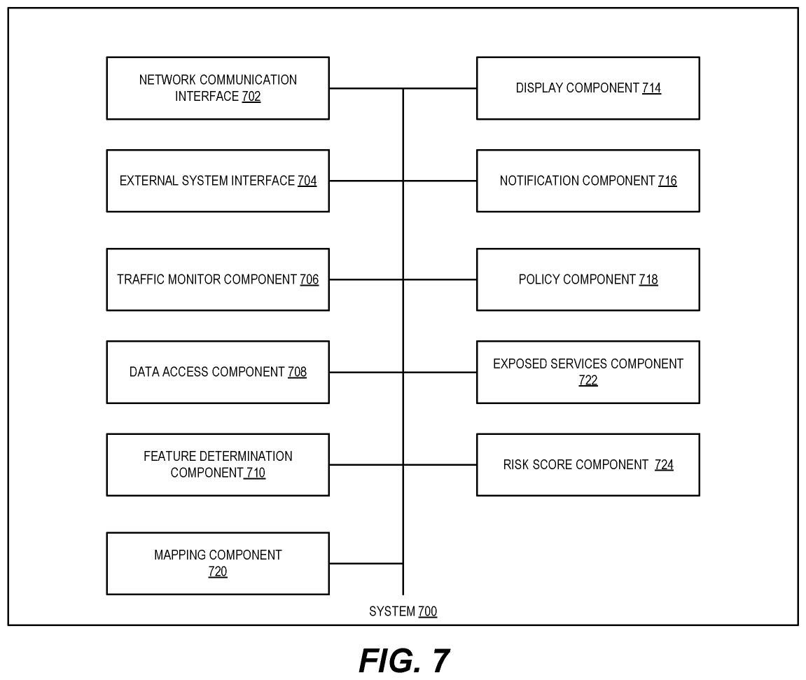

FIG. 7 illustrates example components used by various embodiments. Although specific components are disclosed in system 700, it should be appreciated that such components are examples. That is, embodiments are well suited to having various other components or variations of the components recited in system 700. It is appreciated that the components in system 700 may operate with other components than those presented, and that not all of the components of system 700 may be required to achieve the goals of system 700.

FIG. 7 depicts illustrative components of a system for determining a risk level of a device or entity based on exposed services of a device or entity coupled to a network in accordance with one implementation of the present disclosure. Example system 700 or classifier 700 includes a network communication interface 702, an external system interface 704, a traffic monitor component 706, a data access component 708, a feature determination component 710, a display component 714, a notification component 716, a policy component 718, mapping component 720, exposed services component 722, and a risk score component 724. The components of system 700 may be part of a computing system or other electronic device (e.g., network monitor entity 102 or network monitor entity 280) or a virtual machine or device and be operable to monitor one or more entities communicatively coupled to a network, monitor network traffic, determine one or more classifications of an entity, identify and rank exposed services of a device or entity coupled to a network, determine a risk score associated with an entity, or perform one or more actions (e.g., security action, remediation action, etc.), as described herein. For example, the system 700 may further include a memory and a processing device, operatively coupled to the memory, which may perform the operations of or execute the components of system 700. The components of system 700 may access various data and characteristics or features associated with an entity (e.g., network communication information) and data associated with one or more entities. It is appreciated that the modular nature of system 700 may allow the components to be independent and allow flexibility to enable or disable individual components or to extend, upgrade, or combination thereof components without affecting other components thereby providing scalability and extensibility. System 700 may perform one or more blocks of flow diagrams 400-600. In some embodiments the components of 700 may be part of network monitor device (e.g., network monitor entities 102 and 280), in the cloud (e.g., classification system 262, risk assessment system 272, etc.), or the various components may be distributed between local and cloud resources.

Communication interface 702 is operable to communicate with one or more entities (e.g., network device 104, firewall 206, switch 210, other entities coupled thereto, devices 220-222, etc.) coupled to a network that are coupled to system 700 and receive or access information about entities (e.g., device information, device communications, device characteristics, features, etc.), access information as part of a passive scan, send one or more requests as part of an active scan, receive active scan results or responses (e.g., responses to requests), as described herein. The communication interface 702 may be operable to work with one or more components to initiate access to characteristics or determination of characteristics of an entity to allow determination of one or more features which may then be used for device compliance, asset management, standards compliance, classification, identification, risk assessment or analysis, vulnerability assessment or analysis, etc., as described herein. Communication interface 702 may be used to receive and store network traffic for determining features, as described herein.

External system interface 704 is operable to communicate with one or more third party, remote, or external systems to access information including characteristics or features of an entity (e.g., to be used to determine a security aspects). External system interface 704 may further store the accessed information in a data store. For example, external system interface 704 may access information from a vulnerability assessment (VA) system to enable determination of one or more compliance or risk characteristics associated with the entity. External system interface 704 may be operable to communicate with a vulnerability assessment (VA) system, an advanced threat detection (ATD) system, a mobile device management (MDM) system, a firewall (FW) system, a switch system, an access point (AP) system, etc. External system interface 704 may query a third party system using an API or CLI. For example, external system interface 704 may query a firewall or a switch for information (e.g., network session information) about an entity or for a list of entities that are communicatively coupled to the firewall or switch and communications associated therewith. In some embodiments, external system interface 704 may query a switch, a firewall, or other system for information of communications associated with an entity.

Traffic monitor component 706 is operable to monitor network traffic to determine if a new entity has joined the network or an entity has rejoined the network and monitor traffic for analysis by data access component 708, feature determination component 710, mapping component 720, exposed services component 722, and a risk score component 724, as described herein. Traffic monitor component 706 may have a packet engine operable to access packets of network traffic (e.g., passively) and analyze the network traffic. The traffic monitor component 706 may further be able to access and analyze traffic logs from one or more entities (e.g., network device 104, system 150, or aggregation device 106) or from an entity being monitored. The traffic monitor component 706 may further be able to access traffic analysis data associated with an entity being monitored, e.g., where the traffic analysis is performed by a third-party system.

Data access component 708 may be operable for accessing data including metadata associated with one or more network monitoring entities (e.g., network monitor entities 102 or 280-282), including features that the network monitoring entity is monitoring or collecting, software versions (e.g., of the profile library of the network monitoring entity), and the internal configuration of the network monitoring entity. The data accessed by data access component 708 may be used by embodiments to perform classification including ensuring that the most up to date CVEs, models, entity profiles, and other entity risk information is being used (e.g., by mapping component 720, exposed services component 722, or risk score component 724). Data access component 708 may further access vertical or environment data and other user associated data, including vertical, environment, common type of entities for the network or network portions, segments, areas with classification issues, etc., which may be used for classification.

Data access component 708 may access data associated with active or passive traffic analysis or scans or a combination thereof. Information accessed by data access component 708 may be stored, displayed, and used as a basis for identification and ranking of exposed services for entities coupled to a network, as described herein.

Feature determination component 710 is configured to determine one or more features associated with an entity, as described herein. Feature determination component 710 may determine one or more features and associated values associated with an entity based on analysis (e.g., including extraction of features and values) of network traffic, as described herein. In some examples, a device attribute may be general attributes of a class or classes of devices while device features may be values associated with operation of individual devices, or entities. The features can then be stored and used by other components (e.g., mapping component 720, exposed services component 722, and a risk score component 724) to identify and rank exposed services of entities of a network, as described herein.

Display component 714 is configured to optionally display one or more graphical user interfaces or other interfaces (e.g., command line interface) for depicting various information associated with entities, entity classification, and exposed services at open ports of entities on the network, as described herein. In some embodiments, display component 714 may display or render a network graph of entities including one or more device attributes or classifications, access rules associated with entities, other access rule information (e.g., access policies, access templates, etc.), or explanations of device attribute assignments or conflicts.

Notification component 716 is operable to initiate one or more notifications based on the results of one or more classifications and other analysis of communications, as described herein. The notification may be any of a variety of notifications, e.g., IT ticket, email, SMS, a HTTP notification, conflict alerts, etc., as described herein.

Policy component 718 is operable for initiating or triggering one or more remediation actions or security actions according to one or more policies, e.g., based on one or more classifications, exposed services, and entity risk scores, as described herein. Policy component 718 may further be configured to perform other operations including checking compliance status, finding open ports, etc. In some embodiments, policy component 718 may verify that an assignment of one or more access rules to one or more enforcements points has been properly assigned or configured. Policy component 718 may restrict network access, signal a patch system or service, signal an update system or service, etc., as described herein. The policy component 718 may thus, among other things, invoke automatically (e.g., without user or human interaction) patching, automatically updating, and automatically restrict network access of an entity (e.g., that has out-of-date software or based on access rule violation or attempted violation).

The actions may include restricting network access to a particular level (e.g., full, limited, or no network access, for instance via an enforcement point), remediation actions (e.g., triggering patch systems or services, triggering update systems or services, triggering third party product action, etc.), informational actions (e.g., sending an email notification to a user or IT administrator or creating an IT ticket reflecting the level of compliance), and logging actions (e.g., logging or storing the compliance level).

Mapping component 720 may generate, update, obtain, or a combination thereof one or more mapping lists for different types of devices and domains that may be coupled to a network. The mapping lists may include the available ports on the devices and the services that are associated (e.g., operate behind) each of the available ports for such devices. The mapping lists may include the protocols for the corresponding service and port as well as a security impact level of the service (e.g., the security risks posed by the service). The exposed services component 722 may identify open ports associated with a device that is coupled to a network (e.g., based on open port information gathered by traffic monitor component 706 and/or data access component 708). The exposed services component 722 may query the mapping list for the type of device that is being assessed to identify the services that are exposed by the open ports of the device. In some examples, the exposed services component 722 may directly determine the services used at open ports of a device or entity based on information extracted from network traffic of the device (e.g., via deep packet inspection). The risk score component 724 may generate a risk score and risk assessment for the device based on the exposed services for the device and the impact levels associated with the exposed services.

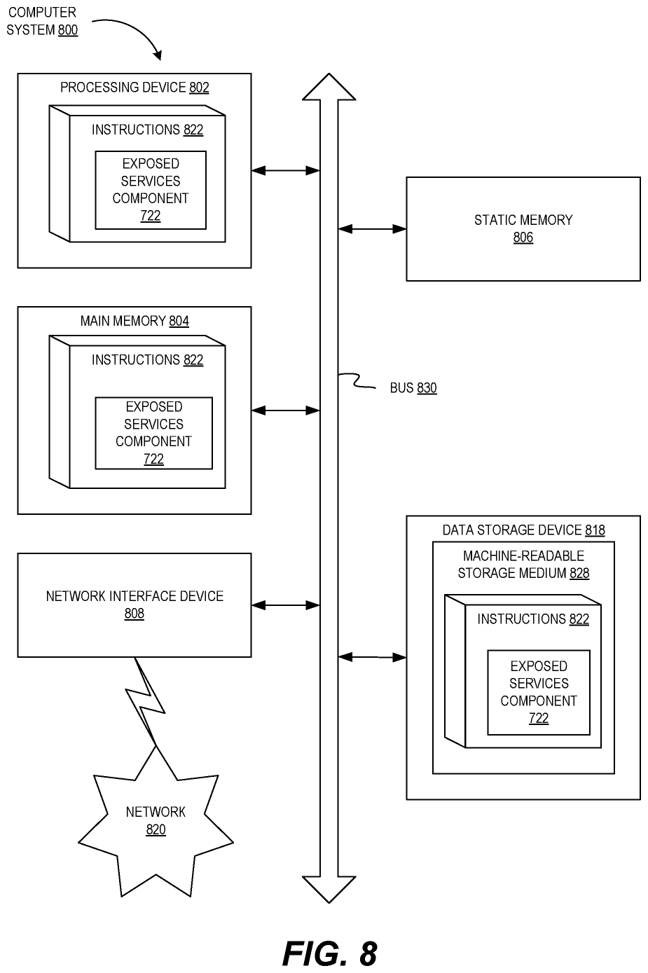

FIG. 8 is a block diagram illustrating an example computer system, in accordance with one implementation of the present disclosure. FIG. 8 illustrates a diagrammatic representation of a machine in the example form of a computer system 800 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 800 may be representative of a server, such as network monitor entity 102 running system 800 to perform identification and ranking of exposed services for one or more entities of a network, as described herein.

The exemplary computer system 800 includes a processing device 802, a main memory 804 (e.g., read-only memory (ROM), flash memory, dynamic random access memory (DRAM), a static memory 806 (e.g., flash memory, static random access memory (SRAM), etc.), and a data storage device 818, which communicate with each other via a bus 830. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 is configured to execute instructions 822, which may be one example of system 700 shown in FIG. 7, for performing the operations and steps discussed herein.

The data storage device 818 may include a machine-readable storage medium 828, on which is stored one or more set of instructions 822 (e.g., software) embodying any one or more of the methodologies of operations described herein, including instructions to cause the processing device 802 to execute modules of system 700 (e.g., exposed services component 722, risk score component 724, mapping component 720, etc.). The instructions 822 may also reside, completely or at least partially, within the main memory 804 or within the processing device 802 during execution thereof by the computer system 800; the main memory 804 and the processing device 802 also constituting machine-readable storage media. The instructions 822 may further be transmitted or received over a network 820 via the network interface device 808.

The machine-readable storage medium 828 may also be used to store instructions to perform a method of identifying and ranking exposed services of an entity coupled to a network, as described herein. While the machine-readable storage medium 828 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
determining one or more services exposed by one or more open ports of an entity;
determining, by a processing device, a level of exposure associated with the service corresponding to each of the one or more open ports of the entity; and
determining, by the processing device, a risk level associated with the entity based at least in part on the level of exposure associated with the service corresponding to each of the one or more open ports of the entity.

2. The method of claim 1, further comprising:
identifying one or more open ports associated with the entity; and
determining the one or more services exposed by the one or more open ports of the entity.

3. The method of claim 2, wherein identifying the one or more open ports associated with the entity comprises:
monitoring network traffic associated with the one or more open ports, the network traffic comprising one or more properties associated with the one or more open ports; and
identifying the one or more open ports based on the one or more properties of the open ports included in the network traffic.

4. The method of claim 2, wherein determining the one or more services exposed by the one or more open ports of the entity comprises:
obtaining a mapping list of ports and services associated with the one or more open ports; and
determining the one or more services exposed by the one or more open ports of the entity based on the mapping list.

5. The method of claim 1, wherein determining the one or more services exposed by ports of the entity comprises:
monitoring network traffic associated with the entity; and
determining the one or more services based on the network traffic associated with the entity.

6. The method of claim 1, further comprising:
determining an impact level associated with each of the services exposed by the one or more open ports of the entity.

7. The method of claim 6, wherein determining the risk level of the entity is further based on the impact level associated with each of the services exposed by the one or more open ports.

8. A system comprising:
a memory; and
a processing device, operatively coupled to the memory, to:
determine one or more services exposed by one or more open ports of an entity;
determine a level of exposure associated with the service corresponding to each of the one or more open ports of the entity; and
determine a risk level associated with the entity based at least in part on the level of exposure associated with the service corresponding to each of the one or more open ports of the entity.

9. The system of claim 8, wherein the processing device is further to:
identify one or more open ports associated with the entity; and
determine the one or more services exposed by the one or more open ports of the entity.

10. The system of claim 9, wherein to identify the one or more open ports associated with the entity, the processing device is to:
monitor network traffic associated with the one or more open ports, the network traffic comprising one or more properties associated with the one or more open ports; and
identify the one or more open ports based on the one or more properties of the open ports included in the network traffic.

11. The system of claim 9, wherein to determine the one or more services exposed by the one or more open ports of the entity, the processing device is to:
access a mapping list of ports and services associated with the one or more open ports; and
determine the one or more services exposed by the one or more open ports of the entity based on the mapping list.

12. The system of claim 8, wherein to determine the one or more services exposed by ports of the entity, the processing device is to:
monitor network traffic associated with the entity; and
determine the one or more services based on the network traffic associated with the entity.

13. The system of claim 8, wherein the processing device is further to:
determine an impact level associated with each of the services exposed by the one or more open ports of the entity.

14. The system of claim 13, wherein the processing device is to determine the risk level of the entity based on the impact level associated with each of the services exposed by the one or more open ports.

15. A non-transitory computer readable storage medium including instructions that, when executed by a processing device, cause the processing device to:
determine one or more services exposed by one or more open ports of an entity;
determine a level of exposure associated with the service corresponding to each of the one or more open ports of the entity; and
determine a risk level associated with the entity based at least in part on the level of exposure associated with the service corresponding to each of the one or more open ports of the entity.

16. The non-transitory computer readable medium of claim 15, wherein the processing device is further to:
identify one or more open ports associated with the entity; and
determine the one or more services exposed by the one or more open ports of the entity.

17. The non-transitory computer readable storage medium of claim 16, wherein to identify the one or more open ports associated with the entity, the processing device is to:
monitor network traffic associated with the one or more open ports, the network traffic comprising one or more properties associated with the one or more open ports; and
identify the one or more open ports based on the one or more properties of the open ports included in the network traffic.

18. The non-transitory computer readable storage medium of claim 16, wherein to determine the one or more services exposed by the one or more open ports of the entity, the processing device is to:
access a mapping list of ports and services associated with the one or more open ports; and
determine the one or more services exposed by the one or more open ports of the entity based on the mapping list.

19. The non-transitory computer readable storage medium of claim 15, wherein to determine the one or more services exposed by ports of the entity, the processing device is to:
monitor network traffic associated with the entity; and
determine the one or more services based on the network traffic associated with the entity.

20. The non-transitory computer readable storage medium of claim 15, wherein the processing device is further to:
determine an impact level associated with each of the services exposed by the one or more open ports of the entity; and
determine the risk level of the entity based on the impact level associated with each of the services exposed by the one or more open ports.
